(19) United States
(12) Patent Application Publication
(10) Pub. No.: US 2013/0276541 A1
(43) Pub. Date: Oct. 24, 2013

(54) VIBRATION METER

(71) Applicants: Dieter Busch, Ismaning (DE); Alexander Kuchler, Unterschleissheim (DE); Heinrich Lysen, Garching (DE)

(72) Inventors: Dieter Busch, Ismaning (DE); Alexander Kuchler, Unterschleissheim (DE); Heinrich Lysen, Garching (DE)

(73) Assignee: Pruftechnik Dieter Busch AG, Ismaning (DE)

(21) Appl. No.: 13/977,372

(22) PCT Filed: Dec. 30, 2011
(86) PCT No.: PCT/DE2011/075326

§ 371 Date: Jun. 28, 2013

(30) Foreign Application Priority Data
Dec. 30, 2010 (DE) 10 2010 056 466.4

(51) Int. Cl. G01H 11/06; G01H 11/08

(52) U.S. Cl. CPC G01H 11/06; G01H 11/08
USPC 73/649

(57) ABSTRACT

A compact vibration meter has at least two vibration sensors which sense vibrations at regions of a support element, the detected vibrations being adjusted to the frequency range to be sensed by the respective sensor.

### BACKGROUND OF THE INVENTION

1. Field of the Invention

The invention relates to a portable vibration meter which can be made very compact, which enables measurement over a wide frequency range, and which can be placed easily and quickly by hand against a measurement site.

2. Description of Related Art

U.S. Pat. No. 6,006,164 describes a data collector in the form of a portable vibration meter which is coupled to the measurement site via a contact stylus and which transfers the determined vibration data to a portable computer while the meter is still recording further vibration data.

U.S. Pat. No. 7,689,373 describes a system for collecting and analyzing vibration data with at least one sensor which is connected to a data collector via a USB interface. The company C-Cubed, under the name Dataq-CF2, markets a compact flash card which can be inserted into a pocket PC and which can be connected to vibration sensors. In conjunction with a ruggedized pocket PC from the company TDS, vibration data can be recorded and analyzed even under the most severe conditions. In the design as a ruggedized PC, in addition to normal notebooks and PDAs, tablet PCs are also available.

The disadvantage of these designs is that, in all models, the data collector or the pocket PC must be taken along to the measurement site for the vibration measurement.

### SUMMARY OF THE INVENTION

The object of the invention is to find a still more compact design for portable vibration meters, based on the enumerated devices, which still enables a wide frequency range, as can be achieved by using at least two sensors. In accordance with the invention, models are possible whose external configuration corresponds to that of USB memory sticks, MP3 players or voice recorders.

This object is achieved in that the carrier for the sensors is configured such that it supports the coupling of the vibration sensor to the measurement object in the frequency range to which the respective sensor is sensitive. This takes place by skillful choice of the coupling of the areas of the carrier on which the respective sensor is attached, that is, coupling to the remaining carrier. The carriers and sensors are made in several parts.

The invention is described below with reference to the accompanying drawings.

### BRIEF DESCRIPTION OF THE DRAWINGS

FIG. 1 is a plan view of a vibration meter in which the top part of the housing has been removed.

FIG. 2 shows a cross section through the vibration meter of FIG. 1.

FIG. 3 shows a cross section through another model of the vibration meter.

FIG. 4 shows a coupling element and parts of boards.

### DETAILED DESCRIPTION OF THE INVENTION

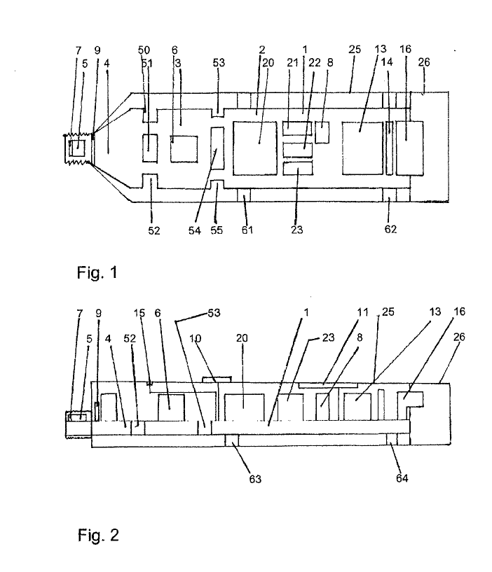

FIG. 1 shows a body 1 which is located in a housing 25. A temperature sensor 7 or a vibration sensor 7 is attached to one end of the body 1. The contact area of this sensor 7 projects out of the housing 25 such that it is possible to place the meter against a measurement site. Recesses 50, 51, 52, 53, 54, and 55 divide the body 1 into three areas 2, 3, 4. The sensor 7 is mounted in the area 4 which also bears a vibration sensor 5. An interface 9 for measurement site recognition is attached between the sensor 7 and vibration sensor 5. Area 4 is connected to area 3 of the body 1 via webs which are formed by the recesses 50, 51 and 52 in the body 1. Another vibration sensor 6 is attached in the area 3. Area 3 is, in turn, connected to the area 2 of the body 1 via webs which are formed by the recesses 53, 54 and 55 in the body 1. The area 2 bears further components which are necessary for the operation of the vibration meter, such as a power supply 20, a processor 21, a memory 22, a communications interface 23 and an inclinometer 8. It is a good idea to provide at least one plug-and-socket connection 16 via which charging of the power supply 20 and/or data exchange with a data collector, a higher-level computer or a computer network takes place. When the data exchange of the vibration meter takes place wirelessly, alternatively or in addition to the plug-and-socket connection 16, there is an antenna 14. Between the processor 21 and the plug-in connector 16 or antenna 14, there is an interface 23 for matching the data which are to be transmitted to the communications protocol. The plug-in connector 16 can project out of the housing 25 and is covered by a protective cap 26. In the housing 25 the body 1 is supported on elements 61, 62.

FIG. 2 shows the same vibration meter in cross section. The same components as in FIG. 1 as well as a microphone 15 are apparent. On the housing 25, there are also one or more keys 10 and one or more displays 11.

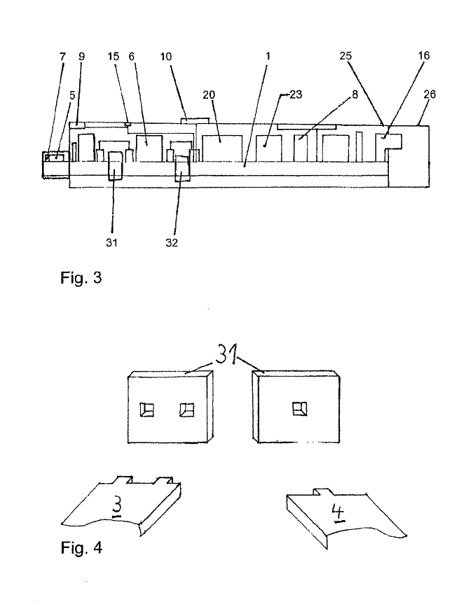

FIG. 3 shows a cross section of another model of the vibration meter. Here, the areas 2, 3, 4 of the body are separated from one another by mechanical coupling elements 31, 32. Furthermore, the measurement site recognition 9 is not attached to the body 1 itself, but to the housing 25. If the mechanical coupling elements 31, 32 do not contain any electrical connections, a respective plug-in connector 44, 45 is attached in each of the areas 2, 3. These plug-in connectors are connected to a cable 46 which is routed around or through the coupling element 32. Accordingly, the electrical connection between the areas 3, 4 takes place via plug-in connectors 41, 42 and a cable 43.

The vibration decoupling between the housing 25 of the vibration meter and the body 1 takes place in the embodiments of FIGS. 1-3 with vibration dampers 61-64 (shown only in FIGS. 1 & 2). It can also be alternatively achieved by using a sealing compound. If the vibration coupling between areas of the body is to be reduced, this is also possible by the dedicated use of such a sealing compound.

FIG. 4 shows two views of a coupling element 31 and two areas 3, 4 of the body which are plugged into openings of the coupling element 31. This coupling element consists of a material which is suitable for controlled transmission of vibrations, such as rubber, silicone, or another elastomer. It can be reinforced, for example, with metal to achieve the desired vibration properties.

Normally, the body 1 is made of metal or plastic. A circuit board is attached to it for making electrical contact with the various sensors. However, in the preferred embodiments shown in the figures, the circuit board itself forms the body 1. Circuit boards are produced from phenolic resin with a paper liner, epoxy resin with a glass fiber liner, or in special cases, from Polytetrafluoroethylene (PTFE). The sensors 5, 6, 7 are mounted as independent modules on the circuit board 1 which forms the body. The subject matter of the invention, at this point, is to match the vibration properties of the areas 2, 3 and 4 to one another such that the frequencies transmitted between the individual areas of the body are tuned to the frequency ranges which are to be measured by the sensors. While in FIG. 1 and FIG. 2 the mechanical connection between the areas 2, 3 and 4 is formed from the circuit boards themselves by webs and suitable recesses which connect the areas in the circuit boards 50-55, in FIG. 3 the mechanical connection between the areas of the body has been formed by separate coupling elements 31, 32. This mechanical connection by way of the selection of materials, sizes and masses makes available the transmission properties between the areas of the body 1 for the selected frequency ranges. While the connections which are nearest the contact surface of the sensor 7 between the areas of the body 1 transmit all frequencies which are relevant to the following sensors 5, 6, other connections which are optionally present are designed such that they transmit only a smaller bandwidth of frequencies of mechanical vibrations. In other words, this means that the transmission bandwidth of the individual connections between the areas will decrease with increasing distance from the contact surface of the sensor.

Preferably, the individual connections are made such that the connection to the last area bearing a sensor, therefore to the area of the body 1 which is farthest away from the contact surface, transmits only the lowest frequency range, for example, from 0 to 1 kHz. A frequency range from 1 or 10 Hz to 1 kHz is dictated by ISO 10816. The next-to-last connection must transmit not only the frequency range which is relevant to the sensor on the next-to-last area which bears a sensor, but also the frequency range which is relevant to the sensor on the last area which bears a sensor. While, for example, the sensor on the next-to-last area of the body which bears a sensor detects a frequency range from 1 kHz to 100 kHz, the connection facing the contact surface of the sensor must transmit the entire frequency range from 0 Hz to 100 kHz so that not only the sensor on the area of the body which is counted as next to last from the contact area can detect vibrations, but also the sensor on the last area.

It is also pointed out that the vibration sensors 5, 6 and 7, if 7 is a vibration sensor, can be made as piezosensors of conventional design or as MEMS modules. Other types of vibration sensors are also possible.

In accordance with the invention, the webs or coupling elements are made such that vibrations are transmitted between the measurement site and the areas 3, 4 such that the transmitted frequencies are tuned to the sensors used. Due to the small size, the invention is executed preferably with sensors which are built in MEMS technology. Of course, all other piezoelectric sensors can also be used. For this purpose, the follow parameters should be suitably chosen:
mass of the area of the body and the components mounted on it, therefore especially of the sensors,
moment of inertia of the area of the body and of the components mounted on it as well as the moment of inertia of a web or an optional coupling element between the areas,
vibration damping properties of the coupling element, and
spring constant for the coupling element which mechanically connects the areas to one another, whether a separate coupling element or a web of a circuit board.

The spring constant can be influenced by the choice of the material of the coupling element. The stiffness in the frequency range under consideration which is described by the material quantities modulus of elasticity and shear modulus is critical here. The vibration damping properties of the coupling element are influenced especially by its shaping. When the webs of the boards form the coupling element, these vibration damping properties can be especially favorably influenced by the size of the recesses 50-55, therefore their geometrical configuration.

While the connection between the housing and the body should have especially good vibration isolation, therefore high elasticity and low stiffness, the coupling to the measurement site should be made with especially low damping, therefore high stiffness and low elasticity. This connection can be favorably produced by the use of a contact stylus which is screwed into the machine part to be measured. Coupling which is favorable for vibration measurement is then achieved by screwing the contact area of the meter into the stylus. It is also possible to press a suitably configured measurement terminal of the vibration meter, for example, into a counterbore or to provide a magnetic connection or cementing. In the latter cases, the coupling for the vibrations is, however, not guaranteed with the same reliability as when screwed to the contact stylus.

The temperature sensor can be both a conventional Pt100 resistance and also another sensor, such as a thermocouple. For the sensor 5, preferably a MEMS module from the company Analog Devices of type ADXL001 is used which measures in one direction of space and is suitable as a detector for shock waves with a resonant frequency of 22 kHz. These shock waves are formed by the motion of mechanically damaged areas, for example, of rolling elements upon impact on the inner ring or outer ring of a bearing. A vibration pick-up 5 which measures in one dimension is sufficient for measurement of shock pulses.

The vibration sensor 6 on the area 3, in a preferred embodiment, is a type LIS3DH module from STMicroelectronics which can measure linear vibrations in all three directions of space and which is especially well suited to vibration measurements in the range from 10 Hz to 20 kHz. A lower boundary of 10 Hz for the frequency range is useful when the vibration meter is pressed only by hand against the measurement site. Then, vibrations of less than 10 Hz can generally be attributed to the movement of the hand or arm of the individual holding the vibration meter. When coupling of the vibration meter takes place via a magnet, cementing or a contact stylus, the lower boundary frequency for the vibration measurement can also be chosen to be smaller.

The components named below are located on the further area 2 of the body. The power source 20 can be a chargeable button cell of type LIR 2450. This button cell is charged via the plug-in connector 16. Alternatively, it can also be charged by an energy harvester integrated into the housing 25. Other versions of the power storage are interchangeable batteries or capacitors.

Likewise, it is possible to place one or more of the components shown in the figures, not on the further area 2, but on the areas 3 and/or 4 when the properties of these components can be favorably used in the parameterization of the frequency behavior of the areas 3 and/or 4. If all of the components located in area 2 can be distributed onto areas 3 and/or 4, the further area 2 can be completely omitted.

Besides the sensors, the processor 21 is also supplied with power from the power source 20. This processor can connect via channels to analog/digital converters for the analog output signals of the sensors. In MEMS sensors, the processor 21 contains a serial interface. A memory 22 and an interface 23 for external communication are also assigned to the processor. Depending on the version of these components, the processor can not only accept the signal of the sensors but can also file it in the memory 22 together with the instant of measurement. It can also undertake continuing computations under program control from the measured values and their time behavior. These computations can be the determination of averages, the computation of the envelope curve or a digital Fourier transform. The results of these computations are then filed again in the memory 22. If the processor 21 has established via the interface 23 a connection to another data collector, a higher-level computer or a computer network, it can transmit the time behavior of the data measured with the sensors and/or the results of the aforementioned computations. The memory 22 can be made entirely or partially in the form of an interchangeable flash memory card such as SD, miniSD or microSD.

On the area 2 with the power source 20 and processor 21 there is, moreover, a uniaxial or multiaxial inclinometer 8 which is likewise made preferably as a MEMS module. The signal of this inclinometer is likewise processed in the processor 21. It is used in vibration measurements on machines with rotating parts to differentiate whether the measurement is being taken in the radial or axial direction with reference to the axis of rotation. In the use of MEMS modules as vibration sensors, it is an approach which is preferred within the scope of the invention if the inclinometer is located not on the area 2 as a separate module, but in a MEMS module 5 or 6 which also contains a vibration sensor.

The described direction recognition takes place advantageously in conjunction with measurement site recognition 9. This measurement site recognition can take place with different detectors. Examples are the mechanical (in conjunction with switches) and magnetic methods for measurement site recognition which are described in EP 0 194 33 and also in EP 0 656 138 and corresponding U.S. Pat. No. 5,691,904. Optical recognition of the measurement site via scanning of a bar code can take place in the same manner as an interrogation of the identity of the measurement site via a radio link, for example, according to the RFID method. If the identity of the measurement site is known to the vibration meter, the inclinometer can be used to check the correct orientation of the meter. Vibration measurements in a radial direction with reference to a rotating component are often taken at measurement sites on which it is necessary to place the vibration meter with the end to be coupled down against the measurement site. In the vibration meter shown in the figures, the end to be coupled is in the vicinity of the temperature sensor 7. The suitable orientation for a measurement in the radial direction is checked with the inclinometer 8 and transmitted to the processor 21. For measurement in the axial, direction the measurement sites are generally mounted such that the vibration meter can be placed against the measurement site in the direction shown in the figures, therefore, with the longitudinal direction in a horizontal orientation.

It is useful to place the device 9 for identification of the measurement site not exactly between the temperature sensor 7 and the vibration sensor 5, but it can be suitably connected to the housing 25 such that there is a visual link to the identification apparatus at the measurement site. In the identification of the measurement site via a bar code, there can be a window in the housing. If a RFID method is used for measurement site identification, the window must be transparent to the electromagnetic waves used. In mechanical or magnetic measurement site identification the corresponding switches or magnet sensors can, likewise, be placed on the side of the meter facing the measurement site next to the temperature sensor or around it.

Depending on the configuration of the vibration meter, the measurement is triggered in different ways. One possibility is to start and stop the measurement by pressing a key 10. When the coupling to the measurement site takes place via a contact stylus which is called a stud, the triggering of the measurement can take place after a time delay from mechanical contact, the amount of the delay that takes place being determined, for example, via a switch. When the meter is placed against the measurement site the triggering of the measurement can also take place program-controlled, when the inclinometer signal indicates a suitable orientation of the meter and/or when the measurement site recognition has identified the measurement site.

After obtaining the result of the interrogation of the identity of the measurement site and/or when there is a suitable input signal from the inclinometer, a program in the processor 21 can also signal via a display 11 that it is now ready to take a measurement. This measurement can be triggered via a key 10. The display can be a light emitting diode or a more complex display of characters and graphic elements, such as, for example, an LCD or OLED display. Combinations of these display elements are also possible.

Via the microphone 15, it is possible to input voice. These voice inputs can, on the one hand, contain the measurement site identification which the user of the vibration meter reads at the measurement site, where they are stored, for example, on one day. However, the user can also undertake voice inputs in order to record observations about the machine state in which he refers, for example, to the oil outlet. If the capacity of the processor 21 is sufficient, this information can be evaluated directly in the vibration meter. But, it is also possible to undertake this evaluation on another computer to which the data from the vibration meter, including the voice inputs, have been transmitted via the interface 23.

The interface 23, for communication with another data collector, higher-level computer or computer network can be executed in different forms. It can be a USB interface. Also, other wire-linked interfaces are possible, such as RS232, LAN or others. For wire-linked interfaces the plug-and-socket connection 16 is used. Also a wireless interface can be provided. The embodiments WUSB, Bluetooth, WLAN can be implemented with commercially available components. Then, the interface 23 uses the antenna 14 for communication.

What is claimed is:

1-19. (canceled)

20. A vibration meter, comprising:
a contact area,
a body and
at least two vibration sensors
the body having at least two areas each of which bears a vibration sensor, each of the areas being mechanically coupled to a respect area of the body that it borders, at least one of the mechanical coupling between each area of the body bearing a vibration sensor and the bordering area and mechanical properties of the area bearing a vibration sensor being constructed to transmit a frequency range which is predetermined for the sensor of that area.

21. The vibration meter as claimed claim 20, wherein there is sensorless area in addition to the at least two areas bearing a vibration sensor.

22. The vibration meter as claimed claim 21, wherein the areas which bear the vibration sensors are coupled to one another and to the sensorless area.

23. The vibration meter as claimed in claim 20, wherein the body with the areas is a circuit board.

24. The vibration meter as claimed in claim 20, wherein the areas are coupled via coupling elements each of which is matched to the predetermined frequency range.

25. The vibration meter as claimed in claim 20, wherein the coupling of the areas is matched to the predetermined frequency range by matching at least one of the following parameters: stiffness of the body, mass of the area of the body, mass of components mounted on the respective area of the body, geometrical shape of the body between the areas, geometrical shape of the coupling element between the areas, mechanical properties of at least one of coupling element and material of the body between the areas or of the coupling element between the areas.

26. The vibration meter as claimed in claim 20, wherein at least one of the vibration sensors is a MEMS sensor.

27. The vibration meter as claimed in claim 20, wherein at least one of the vibration sensors is a piezoelectric sensor.

28. The vibration meter as claimed in claim 20, wherein one of the vibration sensors has a frequency range of 1 Hz, 2 Hz or 10 Hz to 1 kHz and another of the vibration sensors has a frequency range of from 1 kHz to 100 kHz.

29. The vibration meter as claimed in claim 20, wherein at least one of the vibration sensors is sensitive in more than one direction of space.

30. The vibration meter as claimed in claim 21, wherein the sensorless are is mechanically connected to the housing.

31. The vibration meter as claimed in claim 20, further comprising a measurement site recognition device.

32. The vibration meter as claimed in claim 31, wherein the measurement site recognition device is adapted to activate vibration measurement.

33. The vibration meter as claimed in claim 20, further comprising an electric power supply.

34. The vibration meter as claimed in claim 20, further comprising a temperature sensor.

35. The vibration meter as claimed in claim 20, further comprising an inclinometer for determining the spatial orientation of the vibration meter.

36. A vibration meter as claimed in claim 20, further comprising at least one of a data collector, a higher-level computer and a computer network coupled to a measurement output via a wireless interface.

37. A vibration meter as claimed in claim 20, further comprising at least one of a higher-level computer and a computer network via a wire-linked interface.

38. The vibration meter as claimed in claim 37, wherein the wire-linked interface is a USB interface.
